(19) United States
(12) Patent Application Publication
(10) Pub. No.: US 2004/0088362 A1
(43) Pub. Date: May 6, 2004

(54) System and method for automatically manipulating electronic calendar invitations

(76) Inventors: David Curbow, Sunnyvale, CA (US); Durai Balusamy, Santa Clara, CA (US)

Correspondence Address: WAGNER, MURABITO & HAO LLP, Third Floor, Two North Market Street, San Jose, CA, 95113, US

(21) Appl. No.: 10/287,980

(22) Filed: Nov. 4, 2002

(51) Int. Cl. G06F 15/16

(52) U.S. Cl. 709/207; 709/206

(57) ABSTRACT

A computer implemented method and system for filtering electronic invitations based on inherent characteristics of the electronic invitation. In embodiments of the present invention, an electronic calendar invitation filtering system receives an invitation, examines the header information such as a sender's name or subject, determines if a rule has been established for invitations with the characteristics of the incoming invitation, and if there has been a rule set up, implements an action. In another embodiment, when electronic invitation with a particular subject or sender is received, the invitation will be automatically accepted or rejected. Additionally, in another embodiment, when an electronic invitation is received from a particular sender, the invitation will be delegated to another user. Furthermore, in another embodiment, when an electronic invitation from a particular sender is received, the system will schedule the meeting in a calendar. Moreover, if there is a double booking, priority can be given to particular invitations, based on attributes previously mentioned, and the system will give notice to the sender of the previously accepted invitation that the invitation is now declined.

### BACKGROUND OF THE INVENTION

1. Field of the Invention

The present invention relates to the field of data processing. More specifically, embodiments of the present invention relate to a computer-implemented method and system for automatically filtering and managing electronic calendar invitations.

2. Related Art

The widespread proliferation of computers prompted the development of computer networks that allow computers to communicate with each other. With the introduction of the personal computer (PC), computing became accessible to large numbers of people. Networks for personal computers were developed to allow individual users to communicate with each other. As corporations utilize increasingly distributed and open computing environments, the use of electronic calendars has increased substantially. As a result, electronic invitations have become a primary method of inviting many individuals as well as organizations and companies to meetings.

Traditional electronic mail applications such as Microsoft Outlook, Qualcom Eudora, and Netscape Messenger manage electronic mail (e-mail) messages including the application of filters to e-mails.

To aid in managing electronic mail, some e-mail clients have added features to help organize the messages. For example, some e-mail clients offer server-side e-mail management by offering different types of e-mail filtering. Electronic mail filtering can be beneficial because it allows the user to set up rules for tagging messages as “junk mail” and will delete the mail before it goes into the user's in-box. For example, filtering messages about a certain subject could provide significant user benefits by avoiding having to sort through numerous e-mails on a subject of little interest.

Unlike e-mail systems that have user defined rules or filters that automatically process incoming e-mail, today's electronic calendars do not. As a result, every invitation sent to a user in a calendar application must be manually processed by the user and as a result, many invitations are unanswered.

Currently, if the user is invited to a meeting, a manual response is required to process the invitation. Therefore, the user will receive all of the invitations and must process them individually as they arrive. When an individual receives a large volume of invitations, it becomes burdensome and time consuming for users to manually respond to all invitations received. As a result, many times, a user will not respond to an invitation causing uncertainty of attendance.

### SUMMARY OF THE INVENTION

Accordingly, what is needed is a computer implemented system and method for automatically filtering electronic calendar invitations that allows the user to customize rules and allows the conditions and rules to be visible and modifiable to the user. In one aspect, the invention should filter electronic calendar invitations that the user chooses to receive and automatically update an electronic calendar with the appropriate date and time of the meeting.

A computer implemented method and system for automatically filtering and managing electronic calendar invitations based on predefined rules are presented. Embodiments include an electronic invitation filter on an electronic device that is recognizable to the user, requires little training to learn, can be used to perform customizable filtering functions on incoming and outgoing electronic calendar invitations and update a calendar depending on the acceptance or rejection of the invitation.

The present invention allows an electronic calendar invitation to be selected, filtering objectives to be created for particular attributes specific to a particular electronic calendar invitation and then a rule is stored in a filtering engine that performs the desired filtering objectives in the future. Furthermore, when a new calendar invitation is received, the system examines it and determines if it meets previously defined criteria. If so, the filter applies the associated and previously defined action, such as accepting the invitation. By automatically applying rules to incoming electronic calendar invitations, manual user involvement, e.g., the time it takes for an individual to read and respond to electronic invitations, is greatly reduced.

In one embodiment of the present invention, an electronic calendar invitation filtering system receives a calendar invitation, examines the header information such as a sender's name or subject, determines if a rule has been established for invitations with the attributes of the incoming invitation, and if there has been a rule set up, automatically implements an action defined by the applicable rule. Various actions are described below. In another embodiment, when electronic calendar invitation with a particular subject or sender is received, the invitation will be automatically accepted or rejected. Additionally, in another embodiment, when an electronic invitation is received from a particular sender, the invitation will be delegated to another person. Furthermore, in another embodiment, when an electronic invitation from a particular sender is received, the system will schedule the meeting in a calendar database. Additionally, if there is a double booking, priority can be given to particular invitations, based on attributes previously mentioned, and the system will give notice to the sender of the previously accepted invitation that the invitation is now declined.

In another embodiment, the invention allows the user to select an invitation and set up a filtering objective that will allow the filtering engine to create a rule and perform an action on future invitations with similar attributes. For example, a user Tom has been invited by his boss to attend a meeting. Tom always attends meetings when invited by his boss, so he accepts the invitation. The invention would allow Tom to establish a filtering rule that would automatically accept invitations sent from his boss and schedule the meetings in Tom's electronic calendar database. According to one embodiment of the invention, the user selects a shortcut button on the invitation, specifies the criteria field from a menu, i.e., “From invitor” and the senders name or e-mail address would be automatically filled in a dialog box, and selects an action “always accept from sender.” The invention creates a rule that will automatically accept all invitations from Tom's boss and automatically schedule the meetings in Tom's electronic calendar database. Now, when an invitation arrives from Tom's boss, the invitation will automatically be accepted and the user will not see the invitation in their specified folder for storing received invitations. In addition, the meeting will be automatically scheduled in Tom's electronic calendar.

In addition to filtering incoming calendar invitations, it is beneficial to filter outgoing calendar invitations. For example, if a user wanted to keep track of responses to a particular invitation sent, a filtering rule could be established that kept a copy of the invitation responses in a particular folder. Furthermore, a user could create a filtering rule that saves copies of all sent invitations sent in different folders based on the subject information. Filtering outgoing invitations could also be beneficial if multiple persons are invited to a meeting and one or more people can not attend. A filtering rule could be created that canceled meetings if a predetermined number of persons declined the invitation. In one embodiment of the present invention, a user can select a calendar invitation that was sent or received and manually apply rules to the selected calendar invitation to achieve the desired sensitivity of filtering.

These and other objects and advantages of the present invention will no doubt become obvious to those of ordinary skill in the art after having read the following detailed description of the preferred embodiments, which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a logical block diagram of an exemplary computer system in accordance with an embodiment of the present invention.

FIG. 2 is a logical block diagram of an electronic calendar invitation management system in accordance with an embodiment of the present invention.

FIG. 3A is a flow chart of creating a rule associated with an electronic invitation management system in accordance with one embodiment of the present invention.

FIG. 3B is a flow chart of an electronic calendar invitation management process in accordance with an embodiment of the present invention.

FIG. 3C is a flow chart of creating an action associated with a rule that is part of an electronic invitation management system in accordance with one embodiment of the present invention.

FIGS. 4A and 4B are flow diagrams illustrating the process of matching objective criteria to rules and performing actions on electronic calendar invitations in accordance with an embodiment of the present invention.

FIGS. 5A and 5B are flow diagrams illustrating the process of executing rule-based actions on electronic calendar invitations in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

### Notation and Nomenclature

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “setting,” “storing,” “scanning,” “receiving,” “sending,” “disregarding,” “entering,” or the like, refer to the action and processes (e.g., processes 100, 400, 420, and 500) of a computer system or similar intelligent electronic computing device, that manipulates and transforms data represented as physical (electronic) quantities within the computer system's registers and memories into other data similarly represented as physical quantities within the computer system memories or registers or other such information storage, transmission or display devices.

Referring now to FIG. 1, a block diagram of exemplary computer system 12 is shown. It is appreciated that computer system 12 of FIG. 1 described herein illustrates an exemplary configuration of an operational platform upon which embodiments of the present invention can be implemented. Nevertheless, other computer systems with differing configurations can also be used in place of computer system 12 within the scope of the present invention. For example, computer system 12 could be a server system, a personal computer or an embedded computer system such as a mobile telephone or pager system.

Computer system 12 includes an address/data bus 10 for communicating information, a central processor 1 coupled with bus 10 for processing information and instructions, a volatile memory unit 2 (e.g., random access memory, static RAM, dynamic RAM, etc.) coupled with bus 10 for storing information and instructions for central processor 1 and a non-volatile memory unit 3 (e.g., read only memory, programmable ROM, flash memory, EPROM, EEPROM, etc.) coupled with bus 10 for storing static information and instructions for processor 1. Computer system 12 may also contain an optional display device 5 coupled to bus 10 for displaying information to the computer user. Moreover, computer system 12 also includes a data storage device 4 (e.g., disk drive) for storing information and instructions.

Also included in computer system 12 of FIG. 1 is an optional alphanumeric input device 6. Device 6 can communicate information and command selections to central processor 1. Computer system 12 also includes an optional cursor control or directing device 7 coupled to bus 10 for communicating user input information and command selections to central processor 1. Computer system 12 also includes signal communication interface 8, which is also coupled to bus 10, and can be a serial port. Communication interface 8 can also include number of wireless communication mechanisms such as infrared or a Bluetooth protocol.

Although the automatic electronic calendar invitation filtering system of the present invention may be implemented in a variety of different electronic systems such as a computer system, an embedded system, a pager, a mobile phone, a calculator, a personal digital assistant (PDA), etc., one exemplary embodiment includes the implementation on a computer server system. It should be understood that the descriptions corresponding to FIG. 1 provide some general information about an exemplary computing system.

### A System and Method for Automatically Manipulating Electronic Calendar Invitations

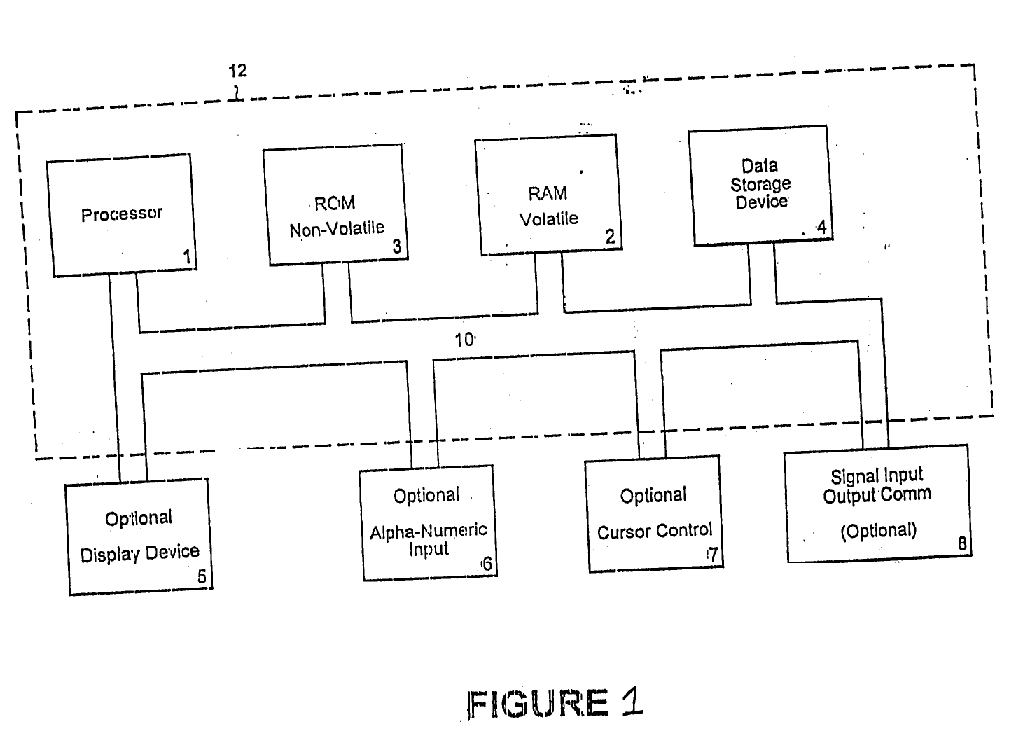

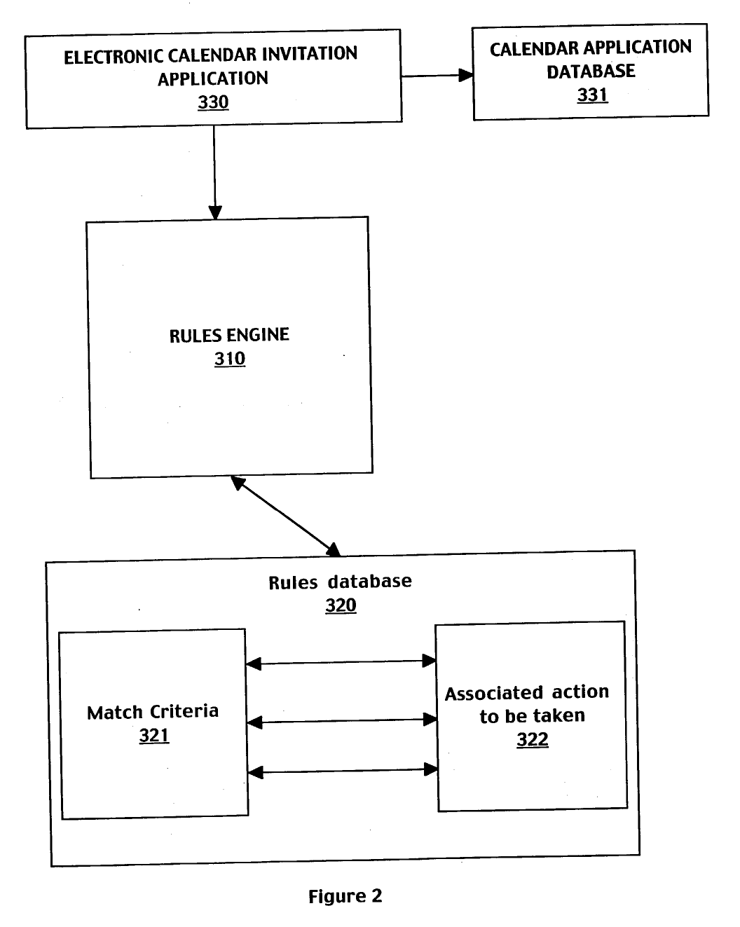

FIG. 2 is a block diagram of computer implemented electronic calendar invitation processing system 330, one embodiment of the present invention. Computer implemented electronic calendar invitation processing system 300 includes a rule engine 310, rules database 320, electronic calendar invitation application 330, and calendar application database 331. Rules engine 310 automatically applies rules for governing management of electronic calendar invitations based on user specified management objectives. In one exemplary implementation, rules engine 310 automatically applies a rule to identify certain invitation scenarios. For example, in one embodiment of the present invention, rules engine 310 automatically applies a rule for recognizing if an electronic calendar invitation is for a meeting scheduled for a time that would cause a double booking in an electronic calendar. The rules engine 310 would examine the time and length of a meeting invitation and compare it to the scheduled entries in the calendar application database 331 to check for conflicts. Rules database 320 is coupled to rules engine 310 and stores the rules.

An invitation match criteria 321 and an associated action 322 define the rules stored in the rules database 320. The invitation classification definition 321 is the particular match criteria that the rules engine 310 uses to match associated actions 322 to calendar invitation scenarios. For example, an invitation classification definition could be a particular sender's name “Jon” and the associated action could be “always accept.” As a result, any invitations sent from “Jon” would be automatically accepted without a manual response from the user. Electronic calendar invitation application 330 accesses the electronic invitations destined for the user.

In one embodiment of the present invention, the rule defines characteristics of electronic invitations and based on said characteristics the rules engine 310 recognizes if the electronic invitation meets a predefined classification, e.g., from a particular user. In one embodiment of the present invention, when the rule engine recognizes that the invitation meets a predefined classification, the rule engine 310 automatically performs an action associated with a rule matching the classification of the invitation. The rules engine 310 can be used for incoming as well as outgoing invitations. For outgoing invitations, an action would be performed after an invitation was sent to other users.

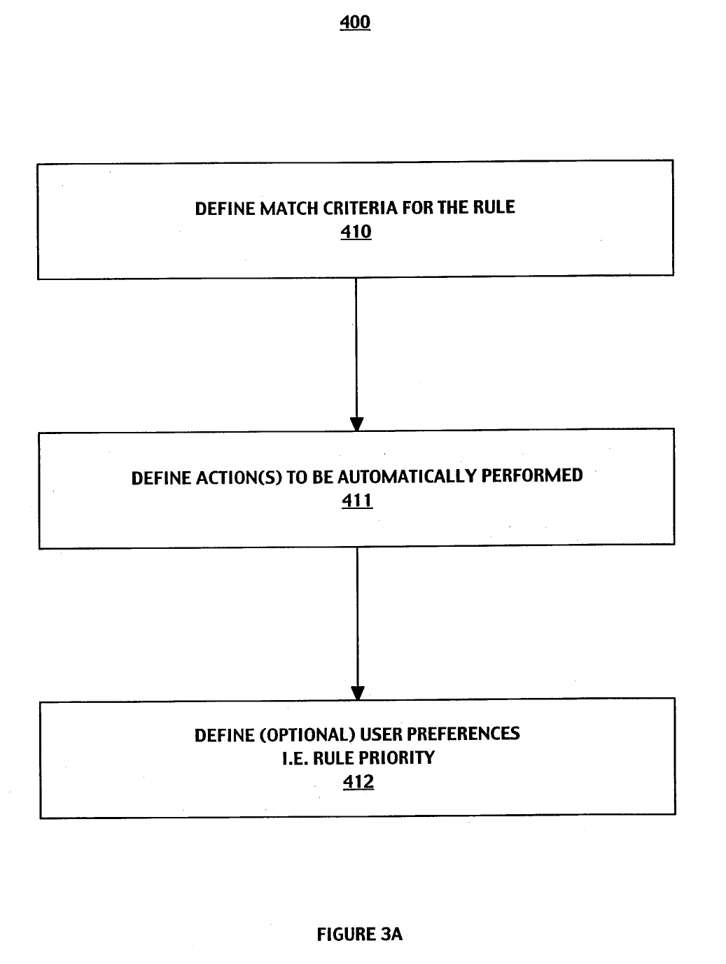

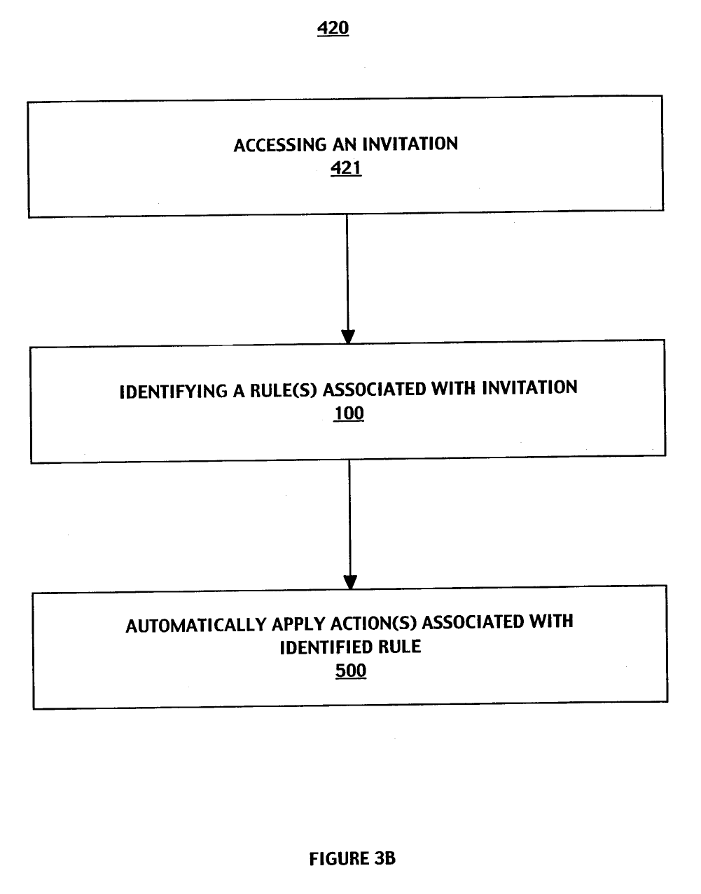

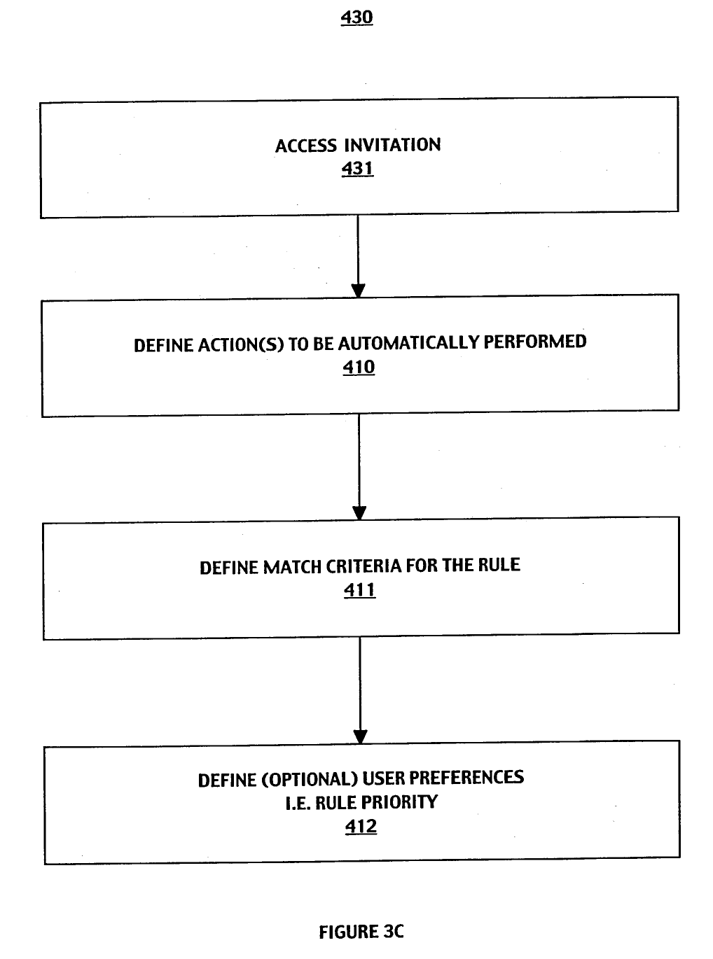

Referring now to FIG. 3A, a flow diagram 400 of creating a rule associated with an electronic invitation management objective in accordance with one embodiment of the present invention. FIG. 3A illustrates the process of creating a rule having match criteria and an associated action to be automatically performed in the future on electronic calendar invitations sharing the matching criteria of the rule. The next step 410 of creating a rule is to define the match criteria for the filtering rule. Examples of specific match criteria are sender name, invitees, subject, key word(s) from the text body, meeting location and meeting duration. The match criteria can be very specific or broad depending on the level of filtering desired by the user. For example, a broad match criteria would be “board members” and a specific march criteria would be “Mr. Thompson.” In one embodiment of the present invention, the rule engine checks a corporate directory for “board members” and applies the matching rule to invitations sent from any individual that is a “board member.”

The next step 411 in creating a calendar invitation management rule is to define an action or actions that are to be automatically implemented on the invitations by the rule engine. For example, an automatic action could be an automatic acceptance of invitations from a particular user. For instance, a user may wish to automatically accept invitations from a direct supervisor. Another action associated with a rule could be the automatic rejection of invitations for meetings that resulted in a double booking in an electronic calendar database.

In the next optional step 412, a rule priority can be specified. Rule priorities alleviate complications that could arise when more than one rule matches an invitation. If more than one criteria matches a particular invitation, the rule priority would decide which rule and associated action would be applied to the invitation. In one embodiment of the present invention, a default rule priority is defined if the user does not create one.

FIG. 3B is a flow diagram 420 describing how the rule engine accesses an invitation, identifies an appropriate criteria and performs an associated action(s) on the invitation in accordance with an embodiment of the present invention. In step 421, an electronic calendar invitation is accessed. In one embodiment, of the present invention the electronic calendar invitation is received by a personal computer. For example, a user receives an electronic calendar invitation delivered via the Internet to the user's personal computer. In another embodiment, a user receives a calendar invitation over a corporate Intranet.

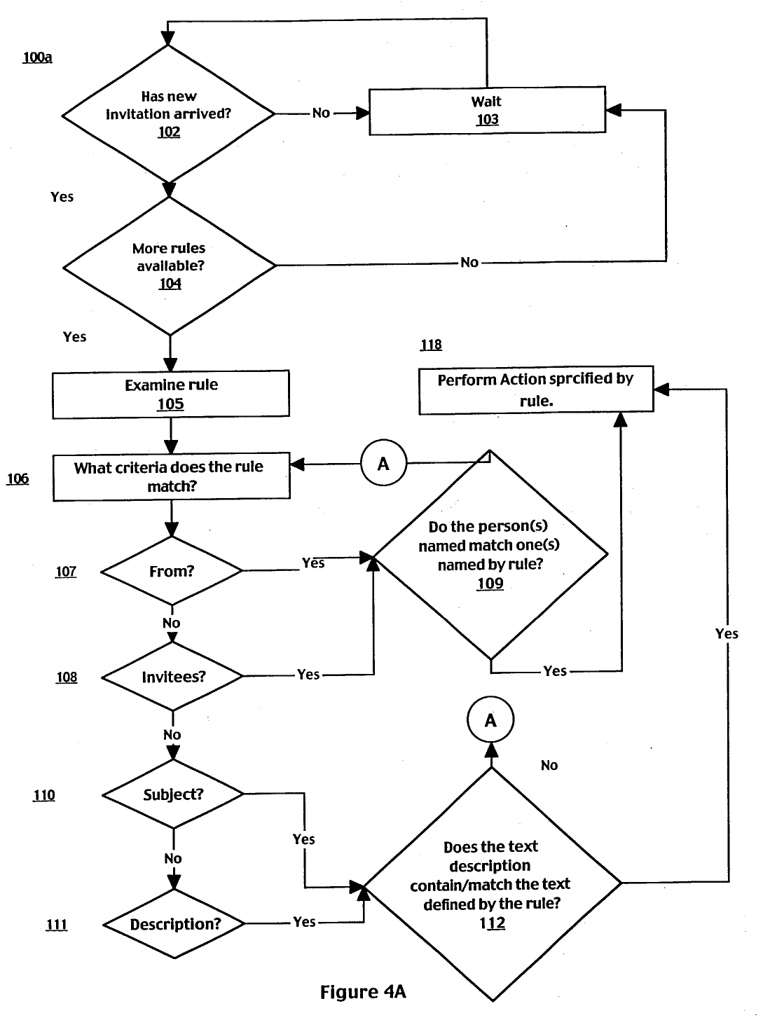

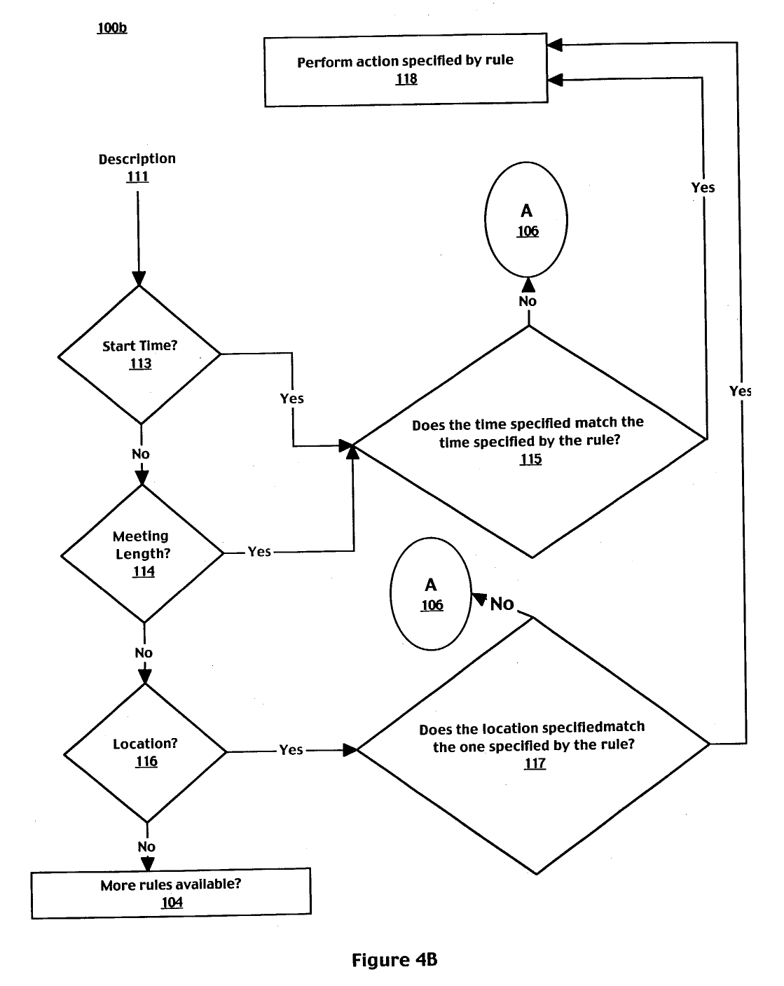

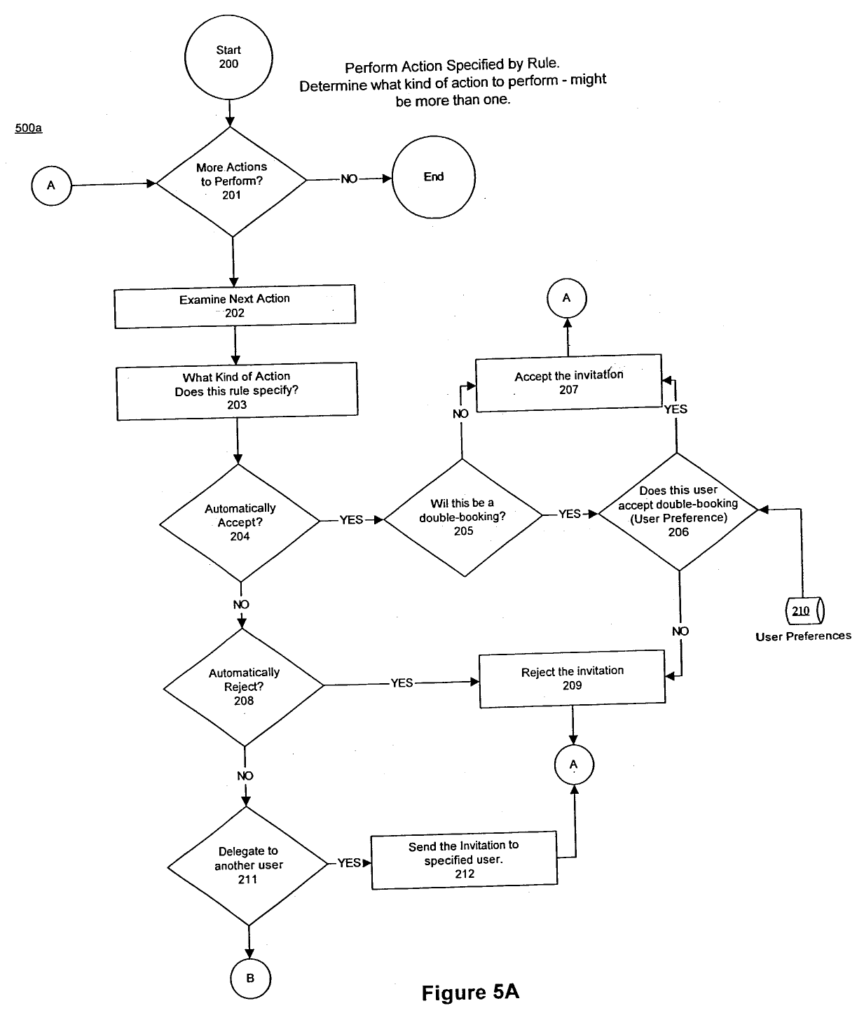

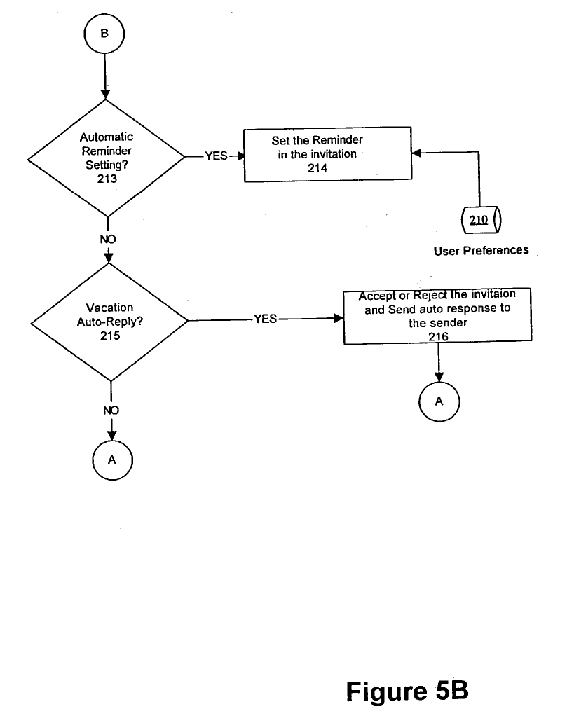

In step 100, the rule engine searches for attributes of an electronic calendar application that match specified characteristics defined in the rules database. Step 100 is described in more detail in FIGS. 4A and 4B. If a match is not found, the user will be presented with the option to create a new rule specific to attributes of the new invitation. This process is described in more detail in FIG. 3C. In step 500, the rule engine finds a rule that matches characteristics of the invitation and the associated action is automatically applied to the invitation without user involvement. The process of automatically performing actions on invitations is described in more detail in FIGS. 5A and 5B.

FIG. 3C is a flow diagram illustrating the process 430 of creating a rule after accessing an invitation. It is convenient for a user to create filtering rules after accessing an invitation because it allows the user to select attributes specific to a particular invitation and define actions. In addition, if an invitation does not match any rules already established, the rule engine will prompt the user to create a new rule so invitations sent in the future will not require manual processing.

When creating a new rule, a user-friendly interface is presented for indicating an electronic calendar invitation management objective. In one exemplary implementation of the present invention, the electronic calendar invitation objective is the automatic acceptance or rejection of the incoming invitation based on attributes of the invitation such as the sender or the date of the meeting. In one embodiment of the present invention, the user-friendly interface comprises presenting a graphical user interface that questions if a user wishes to “automatically accept” or “reject” invitations from particular senders.

The next steps 410, 411 and 412 in creating a rule and associated action(s) are identical to the steps described in process 400 of FIG. 3A. In FIG. 3C, the process 430 of creating a rule is prompted by accessing an invitation. In one embodiment of the present invention, receiving an invitation that does not match a rule causes the rule engine to prompt user to create a new rule. In another embodiment of the present invention, sending an invitation that does not match a rule causes the rule engine to prompt the user to create a new rule.

FIG. 4A is a flow diagram 100a illustrating the process of identifying a rule associated with attributes of an electronic calendar invitation in accordance with an embodiment of the present invention. The process of matching attributes of an invitation to an associated rule starts with checking if a new invitation has arrived in step 102. Usually an electronic email client or electronic calendar client will periodically check for new invitations sent to a user. If there are no invitations to process, the rule engine will wait 103. If there are new invitations destined to a user, the rule engine will process the invitation and determine if the invitation contains attributes that are a match to rules stored in the rule database 320 in FIG. 2. Once a rule is matched with attribute criteria of an electronic invitation, the rule engine 310 of FIG. 3 searches for more applicable rules 104. If more than one rule matches the attributes of an invitation, the rule engine examines the next rule 105. When examining the rule, the rule engine looks to see what attribute criteria of the invitation the rule matches.

In step 107, the rule engine checks to see “who” the invitation is sent from. In step 109, if the sender's name matches one of the rules, the rule engine will instruct the computer system to execute the action(s) associated with the matching rule in step 118. When the rule is determined to have specified criteria involving the “from” field in step 107 the comparison made in step 109 will examine the appropriate field in the invitation and determine if the match exists. In one embodiment, the rule engine will examine a database (e.g. a corporate directory) to see if the person(s) match a rule specified in the rule database 320 of FIG. 2. This functionality becomes important if the match criteria refers not just to a single person, but to a group, such as “senior staff.” In this case, anytime an invitation arrives from someone who is listed on the “senior staff” group in the corporate directory a match would be made. If there are no matches with any rules, the rule engine will check for another match with a different attribute. For example, in step 108, the rule engine examines the invitees associated with an invitation. If the invitees match a rule then the associated action will be performed in step 118. In step 110, the rule engine looks at the subject portion of the invitation for a matching objective criteria. In one embodiment, the next step 112 is a search of the text portion of the invitation for key word(s) that match a rule in the rule database. If a match is found, the action associated with the matching rule will be executed. In one embodiment, more extensive comparisons such as “begins with” or “exactly matches” are available to the user. In addition comparisons such as metaphorical comparisons can be made. For example, if a user specified interest in meetings whose descriptions contain “dog”, the system would match that as well as all breeds of dogs, such as “collie.”

FIG. 4B is a continuation of flow diagram 100a. In Step 113, the search criteria is the meeting start time of an invitation. The rule engine looks for a start time of the meeting and examines the rule database for a rule that matches the start time of the invitation. In one embodiment, the rule engine would query an electronic calendar database to see if a meeting was already scheduled at the time of the new invitation. The user can customize the associated actions that are performed when a rule match is found. Some users may want the ability to double book a meeting time. In this case, the invitation would be automatically accepted and the meeting would be scheduled in the user's electronic calendar database.

Another search criteria is invitation priority. The rule engine can match invitations to rules based on the invitation priority. A rule could be established that always accepts high priority invitations. In Step 119 the rule engine checks the priority set in the invitation against rules database for a match. If a match found, the actions associated with the rules would be automatically performed. In one embodiment, the rule engine would query an electronic calendar database to see if a meeting was already scheduled at the time of the new invitation. In such a case, some users may want to either double book if existing and new invitations are high priority ones or if existing are low priority than the new one, he could setup a rule to decline the existing meetings and accept the new invitation.

In step 121, the search criteria is the invitation category. The rule engine looks the category specified in the new invitation and examines the rule database for a rule that matches the category of the invitation. For example, if a rule is established that automatically accepts meetings with category “business” or “work”, the invitation would be automatically accepted.

Another search criteria is vacation date range. In step 123, the rule engine looks for the start and end dates of a meeting and if it falls within the vacation date range an automatic reply will be sent out the sender of the invitation. In one embodiment, the user can set the automatic reply to send out and declining the invitation.

Another search criteria is the meeting length. In step 114, the rule engine looks for the length of the meeting. If the meeting length matches an established rule, the associated action will be automatically executed. For example, if a rule is established that automatically rejects meetings with a length of more than one hour and a new invitation has a meeting length of two hours, the invitation would be automatically rejected.

In addition to the meeting length, the rule engine can match invitations to rules based on the location of the meeting. A rule could be established that always accepts meetings at a particular location. In step 116, the rule engine checks the location associated with an invitation against the rule database for a match. If a match is found, the action(s) associated with the rule would be automatically performed. In one embodiment, advanced comparisons such as looking in a database to determine the exact location of a meeting can be made. This would allow the system to automatically reject meetings that are scheduled to take place in a different city from where the user is located.

Another action associated with a rule is the automatic reminder setting of an invitation in step 213. When the action is the automatic reminder setting, the rule engine sets the reminder to the invitation without a manual response by the user in step 214. For example, an action can be to set the reminder 15 minutes before the meeting start time. In step 215, action associated with a rule is automatic reply to the sender. When an action is set to send automatic reply to the sender, the rules engine sends a automatic response to the sender.

If an invitation does not match any of the rule criteria, the invitation will appear in the user's inbox and a manual response will be required. If more than one rule matches the invitation, the rule engine will check if the associated actions are in agreement. For example, if one matching rule instructs to always accept and another matching rule instructs to accept, then there is not a problem. If there are contradictory actions specified by the matching rules, the rule engine will choose one action based on a priority scale. The priority scale can be customized by the user to achieve the desired invitation management objective.

In addition to determining the match criteria on an invitation, the rule engine also determines the type of action associated to a matching rule. FIGS. 5A and 5B are flow diagrams 500a and 500b of executing rule-based actions on electronic invitations in accordance with an embodiment of the present invention. If there is not a matching rule associated with an invitation, the computer system is not instructed to perform actions. When there is a rule that matches attributes of an invitation, the rule engine instructs the computer system to perform automated actions associated with the invitation. When performing actions on invitations, the rule engine examines what kind of action is specified in step 203. One action is the automatic acceptance of an invitation in step 204. If an invitation is automatically accepted, the rule engine checks an electronic calendar database to see if acceptance would result in double booking in step 205. If the invitee is available, the invitation will be automatically accepted in step 207. In addition, if the user accepts double booking, the invitation will be accepted in step 206. Settings such double booking restrictions and rule priorities are stored in a user preference file 210. If the user does not accept double booking, the invitation will be rejected in step 209. In one embodiment of the present invention, after an invitation is rejected due to double booking, the rule engine checks an electronic calendar database for alternative times to meet and then sends a response to the sender containing alternative meeting times.

Another action associated with a rule is the automatic rejection of an invitation in step 208. When the action is the automatic rejection of an invitation, the rule engine sends a rejection response to the sender of the invitation without a manual response by the user. In one embodiment of the present invention, the rule engine gives a graphical notification to the user that an invitation was automatically rejected. This will reduce the chance of rejecting an invitation that would normally have been accepted by the user.

In addition to automatically accepting and rejecting invitations, the rule engine has the capability to delegate the invitation to another user in step 211. For example, a rule could be established that delegates invitations that cause a double booking to an administrative assistant. This functionality allows users to delegate invitations that require additional attention to another person. In one embodiment, a graphical alert would be displayed that notified the user an invitation was delegated to another user.

Embodiments of the present invention, a system and method for automatically manipulating electronic invitations have been described. While the present invention has been described in particular embodiments, it should be appreciated that the present invention should not be construed as limited by such embodiments, but rather construed according to the following claims.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and it's practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. An electronic invitation management process comprising:
presenting a graphical user interface for indicating an electronic invitation management objective with respect to an electronic invitation;
generating an electronic invitation rule to achieve said electronic invitation management objective;
accessing an electronic invitation associated with a calendar application; and
performing actions associated with said electronic invitation rule in response to said electronic invitation.

2. An electronic invitation management process as described in claim 1 wherein said electronic invitation management objective is the automatic acceptance of any electronic invitations from designated senders.

3. An electronic invitation management process as described in claim 2 wherein said electronic invitation rule comprises software code instructions for causing a computer system to automatically send a reply to said electronic invitation.

4. An electronic invitation management process as described in claim 2 wherein said electronic invitation rule comprises software code instructions for causing a computer system to automatically update an electronic calendar database after accepting an electronic invitation.

5. An electronic invitation management process as described in claim 1 wherein said electronic invitation management objective is the automatic delegation of any electronic invitation to another user if acceptance of said electronic invitation would result in a double booking.

6. An electronic invitation management process as described in claim 1 wherein said electronic invitation management objective is the automatic acceptance of any electronic invitations having particular subject headings.

7. An electronic invitation management process as described in claim 1 wherein said electronic invitation management objective is the automatic rejection of any electronic invitation if acceptance would cause a double booking in said calendar application.

8. An electronic invitation management process as described in claim 7 further comprising accessing said calendar application to check for alternate meeting times if a double booking resulted.

9. A computer implemented electronic invitation processing system comprising:
a rules engine for automatically applying a rule for governing management of an electronic invitation;
a rules database coupled to said rules engine, said rules database for storing information defining said rule; and
an electronic invitation application for accessing said electronic invitation destined for a user and for applying said rules engine to said electronic invitation wherein said electronic invitation application comprises an electronic calendar for scheduling said electronic invitations.

10. A computer implemented electronic invitation processing system as described in claim 9 wherein a rule-based action performed by said rules engine is the automatic acceptance of an electronic invitation that is sent from a particular user.

11. A computer implemented electronic invitation processing system as described in claim 10 wherein said rule-based action performed by said rules engine further comprises automatically sending a response to the sender of said electronic invitation.

12. A computer implemented electronic invitation processing system as described in claim 9 wherein a rule-based action is to automatically update said electronic calendar after sending a response to said electronic invitation.

13. A computer implemented electronic invitation processing system as described in claim 9 wherein a rule-based action is to automatically reject an electronic invitation if acceptance of said electronic invitation would result in a double booking.

14. A computer implemented electronic invitation processing system as described in claim 9 wherein a rule-based action is to automatically delegate said electronic invitation to another user.

15. A method for processing electronic calendar invitations comprising:
a) accessing an electronic calendar invitation received over a computer network and associated with a calendar application;
b) automatically identifying a predetermined rule that is applicable to said electronic calendar invitation, wherein said predetermined rule is part of a rules database comprising a plurality of rule definitions;
c) automatically performing an action based on said predetermined rule; and
d) repeating steps a)-c) for a plurality of electronic calendar invitations.

16. A method as described in claim 15 wherein said c) comprises automatically accepting said electronic calendar invitation, wherein said automatically accepting comprises updating a calendar database associated with said calendar application.

17. A method as described in claim 15 wherein said c) comprises automatically rejecting said electronic calendar invitation.

18. A method as described in claim 15 wherein said c) comprises:
automatically accepting said electronic calendar invitation; and
automatically canceling attendance of any previously accepted meetings that conflict with said electronic calendar invitation.

19. A method as described in claim 15 wherein said c) comprises automatically delegating acceptance of said electronic calendar invitation to another user.

20. A method as described in claim 15 wherein said c) comprises:
automatically accepting said electronic calendar invitation; and
automatically rescheduling any previously accepted meetings that conflict with said electronic calendar invitation.

21. A method as described in claim 15 wherein said b) comprises automatically examining a sender field of said electronic calendar invitation to identify said predetermined rule.

22. A method as described in claim 15 wherein said b) comprises automatically examining a recipients field of said electronic calendar invitation to identify said predetermined rule.

23. A method as described in claim 15 wherein said b) comprises automatically examining a subject matter field of said electronic calendar invitation to identify said predetermined rule.

24. A method as described in claim 15 wherein said b) comprises automatically examining information relating to a meeting time of said electronic calendar invitation to identify said predetermined rule.

25. A method as described in claim 15 wherein said b) comprises automatically examining information relating to a meeting location of said electronic calendar invitation to identify said predetermined rule.

26. A method as described in claim 15 further comprising using a graphical user interface to define said predetermined rule, wherein said predetermined rule is user defined and user modifiable.

27. A method as described in claim 15 wherein a rule definition for a given rule comprises:
a classification of electronic calendar invitations that are covered by said given rule; and
an action to be taken.
